(19) United States
(12) Patent Application Publication
(10) Pub. No.: US 2006/0081726 A1
(43) Pub. Date: Apr. 20, 2006

(54) Controlled drop dispensing tips for bottles

(76) Inventor: Scott J. Gerondale, Mission Viejo, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/243,138

(22) Filed: Oct. 3, 2005

Related U.S. Application Data
(60) Provisional application No. 60/618,765, filed on Oct. 14, 2004.

(51) Int. Cl. B05B 1/14

(52) U.S. Cl. 239/590; 239/589

(57) ABSTRACT

A controlled drop dispensing tip for a squeeze bottle includes a nozzle assembly having a needle with a lumen therethrough for flow of liquid formulation and an orifice in fluid communication with a lumen. A shroud is provided and disposed about the needle in order to prevent inadvertent contact of the needle with a users eye. The shroud may partially surround the needle and include an open end with a circumferential opening enabling passage of droplets therepast.

The present invention is generally related to a control drop dispensing system and is more particularly directed to such a system including a dispensing tip enabling uniform droplet dispensment.

Applicators or systems for the delivery or instillation of the liquid formulations into an eye by a user have long been known.

Generally, bottles or vials, which contain eye drop formulations, are flexible and have walls sufficiently thin to enable squeezing of the bottle through a nozzle and dispensing orifice.

In use, the user suspends the bottle over an eye to be treated in an inverted or semi-inverted position in order to direct the nozzle toward the eye. The formulation is expelled as the user manually squeezes the wall of the bottle body or a bottom of the bottle. This pressure differential within the bottle drives out a quantity of formulation which exits the vial or bottle via the nozzle orifice as a droplet and descends through gravity into the eye positioned below the nozzle.

While this procedure appears to be straightforward, it often cannot be performed satisfactorily with small volume bottles in order to dispense uniform drops. In addition to handling problems associated with over squeezing or unintentional squeezing of the bottle, the angle of the bottle and nozzle with regard to the eye is significant in determining the droplet size produced.

The droplet size is important in that the dose prescribed to the patient must often be accurately adhered to. If the quantity which is effectively delivered is insufficient, the treatment may not be efficient. On the other hand, if the quantity delivered is too large the surplus in certain cases may cause side effects. Droplet sizes in the range of 10-20 μl makes the delivery more critical.

Accordingly, it is important to be able to administer an exact dose of the formulation required and the present invention provides for a controlled drop dispensing tip and system enabling uniform droplet dispensment of the liquid formulation independent of downward angular orientation of the tip.

### SUMMARY OF THE INVENTION

A controlled drop dispensing tip for a squeeze bottle in accordance with the present invention generally includes a nozzle assembly having a needle with a lumen therethrough for flow of liquid formulation and an orifice in fluid communication with the lumen having a small diameter for forming the small droplets, preferably in the range of 10-20 micro liters.

A shroud is disposed about the needle in order to prevent inadvertent contact of the needle with the users eye.

More particularly, in one embodiment of the present invention, the shroud partially surrounds the needle and includes an open end with a circumferential opening which enables passage of droplets therepast. In this manner, the nozzle may be held at an approximate 90° angle to a users eye for installation of droplets.

Proper orientation of the tip is provided by a finger guide attached to the nozzle at a position which assures such an orientation of the shroud by a user which allows droplets to pass through the circumferential opening. Preferably, the lumen has an inside diameter less than 0.025 inches in order to control droplet size.

In another embodiment of the present invention, a shroud totally surrounds the needle for preventing contact of the needle with the users eye with the shroud having an open end enabling passage of droplets therepast. In addition, surface charge dissipating fins are disposed approximate the needle end within the needle shroud.

In yet another embodiment of the present invention, a controlled drop tip dispensing tip for a squeeze bottle in accordance with the present invention generally includes a nozzle assembly having a lumen therethrough for flow of liquid formulation in an orifice in fluid communication with the lumen forming droplets. The nozzle is attached to a squeeze bottle and a pressure controlled valve is disposed in the orifice with the valve sealing the orifice when pressurized and open when the orifice and releasing a droplet upon release of pressure.

### BREIF DESCRIPTION OF THE DRAWINGS

The present invention may be more clearly appreciated when taken in conjunction with the accompanying drawings, in which:

FIG. 1 is a perspective view of one embodiment of a controlled drop dispensing tip in accordance with the present invention showing its attachment to a squeeze bottle along with a needle with a surrounding shroud and a finger guide for assuring proper orientation;

FIG. 2 is a side view of the embodiment shown in FIG. 1 in partial cross section;

FIG. 3 is a perspective view of another embodiment of the present invention illustrating a controlled drop dispensing tip attached to a squeeze bottle and including a needle with a surrounding shroud and fins for dissipation of a surface charge;

FIG. 4 is a side view of the embodiment shown in FIG. 3 in partial cross section;

FIG. 5 is a perspective view of yet another embodiment of the present invention showing a controlled drop dispensing tip with a nozzle assembly having a lumen therethrough for flow of liquid formulation along with a pressure controlled valve disposed in the orifice, said valve being shown in a popped out position sealing the orifice in FIG. 5; and

FIG. 6 is a perspective view of the embodiment shown in FIG. 5 with the pressure controlled valve snapped in allowing drop release.

### DETAILED DESCRIPTION

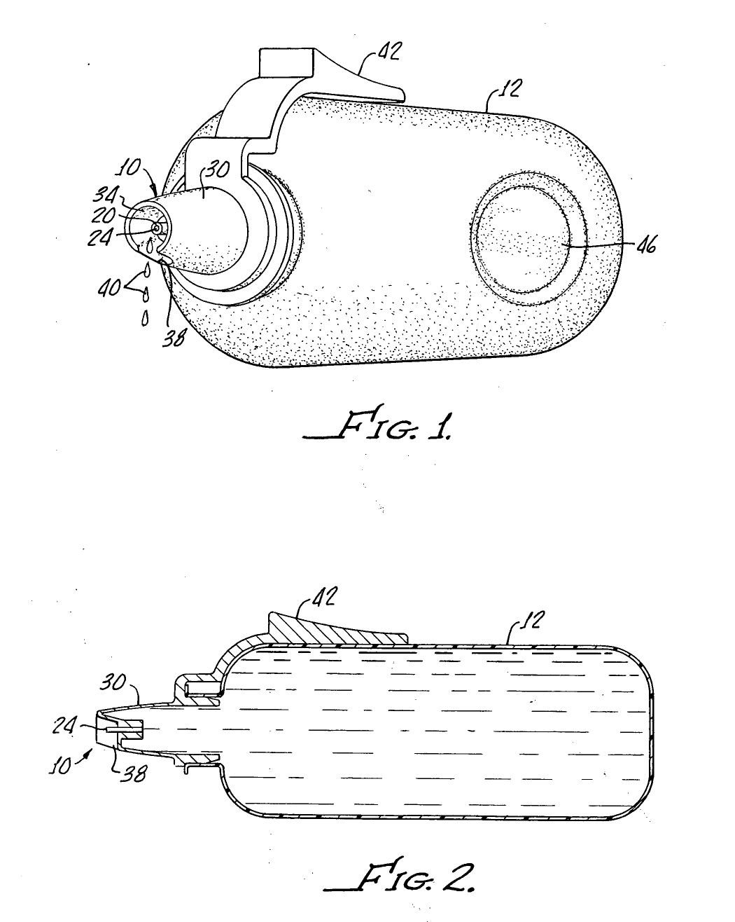

With reference to FIGS. 1 and 2, there is shown a controlled drop dispensing tip 10 for a squeeze bottle 12 in accordance with the present invention for producing droplet sizes in the range of 10-20 μl. The tip 10 generally includes a nozzle assembly 16 having a needle with a lumen 22 (See FIG. 2) therethrough for flow of a liquid formulation and an orifice 24, in fluid communication with the lumen 22, for forming droplets, the nozzle 16 being attachable to the squeeze bottle 22 in a conventional manner. The lumen 22 has an inside diameter of less than about 0.025 inches in order to form small droplets in the range 10-20 μl.

A shroud 30 is provided and partially surrounds the needle 20 to prevent inadvertent contact of the needle 20 with a user's eye (not shown). The shroud 30 includes an open end 34 and a circumferential opening 38 enabling passage of droplets therepast. As shown the bottle 12 is held in a generally horizontal position with droplets departing the nozzle at approximate a 90° angle.

A finger guide 42 is attached to the nozzle 16 at a position assuring proper orientation of said shroud 30 by a user (not shown) allowing droplets to pass through said circumferential opening 38. Finger depressions 46 in the bottle 12 facilitate squeezing of the bottle 12 and also contribute to the users proper orientation of the nozzle 16 for accurate dispensing of droplets through the shroud opening 38.

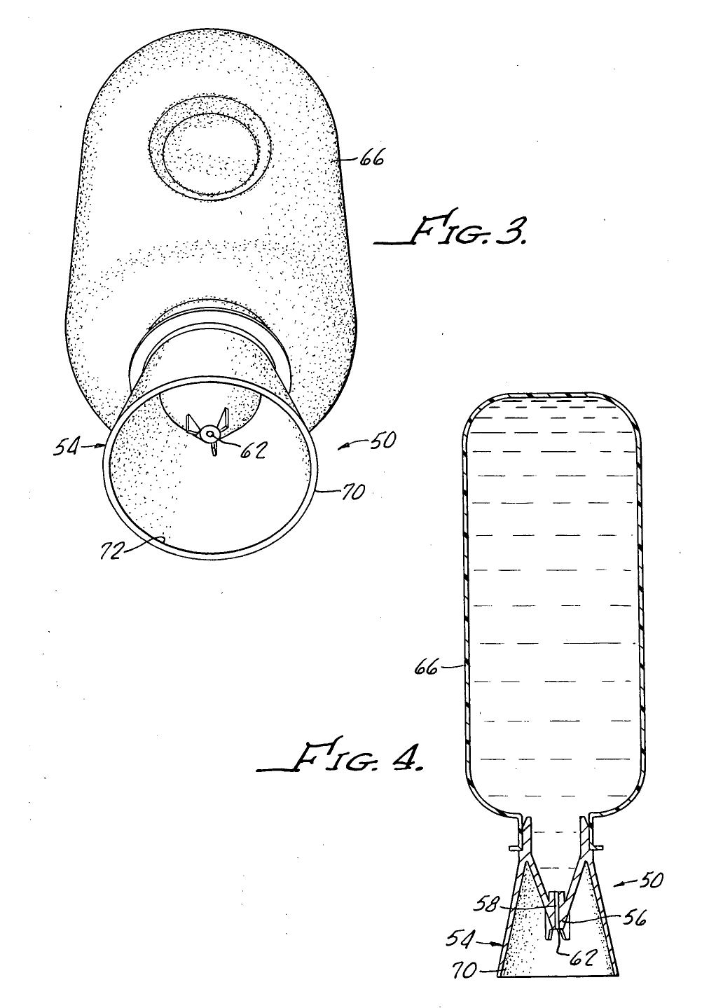

With reference to FIGS. 3 and 4, there is shown another embodiment 50 of the present invention generally showing a nozzle assembly 51 having a needle 56 with a lumen 58 (See FIG. 4) therethrough for flow of a liquid formulation. An orifice 62 is provided and is in fluid communication with said lumen 58 for forming droplets.

The lumen 58 has an inside diameter of less than about 0.025 inches in order to produce small droplets in the range of 10-20 μl. The nozzle 54 is attachable to a squeeze bottle 66 in a conventional manner.

A shroud 70 totally surrounds the needle with the shroud 70 having an open end 72 enabling passage of droplets (not shown) therepast.

The shroud 70 shown in FIGS. 3 and 4 may also function as an eyecup which may be placed around a users eye (not shown) to assure proper orientation of the needle 56 for disposing droplets (not shown) into the users eye and also prevent contact with a user's eye (not shown).

In addition, fins 76 may be disposed proximate the needle 56, and within the shroud 70, for dissipating any surface charge in the needle 56 or area within the shroud 70.

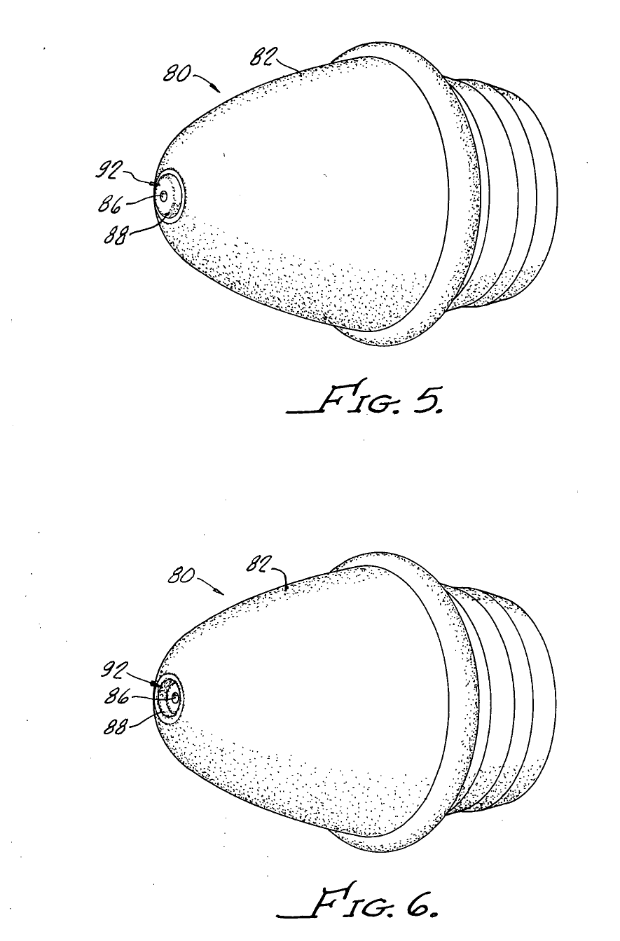

Yet another embodiment 80 of the present invention is shown in FIGS. 5-6. In this embodiment 80, a nozzle assembly 82 includes a lumen 86 therethrough for flow of a liquid formulation. An orifice 88 is provided and is in fluid communication with the lumen 86 for forming droplets (not shown). The nozzle 82 is attachable to a squeeze bottle, not shown in FIGS. 5-6, see however FIGS. 1-4 in a conventional manner.

A pressure controlled valve 92 is disposed in the orifice 88. The valve 92 seals the orifice when pressurized and opens the orifice for releasing a droplet (not shown in FIGS. 5-6) upon release of pressure.

Although there has been hereinabove described a specific controlled drop dispensing tip for bottles in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A controlled drop dispensing tip for a squeeze bottle, the tip comprising:
a nozzle assembly having a needle with a lumen therethrough for flow of a liquid formulation and an orifice, in fluid communication with said lumen, said lumen having a small inside diameter, forming small droplets, in the range of 10-20 μl, said nozzle being attachable to the squeeze bottle; and
a shroud disposed about said needle in order to prevent inadvertent contact of the needle with a user's eye.

2. The tip according to claim 1 wherein said shroud partially surrounds said needle, includes an open end, and has a circumferential opening enabling passage of droplets therepast.

3. The tip according to claim 2 further comprising:
a finger guide attached to said nozzle at a position assuring proper orientation of said shroud by a user allowing droplets to pass through said circumferential opening.

4. The tip according to claim 3 wherein the lumen inside diameter is less than about 0.025 inches.

5. The tip according to claim 1 wherein the shroud totally surrounds said needle to prevent contact of the needle with a user's eye, said shroud having an open end enabling passage of droplets therepast.

6. The tip according to claim 5 further comprising surface charge dissipating fins disposed proximate said needle and within said shroud.

7. The tip according to claim 5 wherein the lumen inside diameter is less than about 0.025 inches.

8. A controlled drop dispensing tip for a squeeze bottle, the tip comprising:
a nozzle assembly having a needle with a lumen therethrough for flow of a liquid formulation and an orifice, in fluid communication with said lumen having a small inside diameter, forming small droplets, in the range of 10-20 μl, said nozzle being attachable to the squeeze bottle;
a shroud totally surrounding said needle preventing contact with a user's eye, said shroud having an open end enabling passage of droplets therepast; and
surface change dissipating fins disposed proximate said needle and within said shroud.

9. The tip according to claim 8 wherein the lumen inside diameter is less than about 0.025 inches.

10. A controlled drop dispensing tip for a squeeze bottle, the tip comprising:
a nozzle assembly having a lumen therethrough for flow of a liquid formulation and an orifice in fluid communication with said lumen forming droplets, said nozzle being attachable to the squeeze bottle; and
a pressure controlled valve disposed in said orifice, said valve sealing said orifice when pressurized and opening said orifice and releasing a droplet upon release of pressure.
